(19) United States
(12) Patent Application Publication
(10) Pub. No.: US 2013/0103441 A1
(43) Pub. Date: Apr. 25, 2013

(54) Generating Predictions for Business Processes Whose Execution is Driven by Data

(71) Applicants: Yurdaer N. Doganata, Hawthorne, NY (US); Rania Yousef Khalaf, Cambridge, MA (US); Geetika T. Lakshmanan, Cambridge, MA (US); Merve Unuvar, Cambridge, MA (US)

(72) Inventors: Yurdaer N. Doganata, Hawthorne, NY (US); Rania Yousef Khalaf, Cambridge, MA (US); Geetika T. Lakshmanan, Cambridge, MA (US); Merve Unuvar, Cambridge, MA (US)

(73) Assignee: International Business Machines Corporation, Armonk, NY (US)

(21) Appl. No.: 13/279,067

(22) Filed: Oct. 21, 2011

(51) Int. Cl. G06Q 10/06

(52) U.S. Cl. 705/7.12

(57) ABSTRACT

A method for generating predictions includes dividing a business process model into fragments, wherein the business process model includes task nodes and at least one decision node, determining the decision node in at least one of the fragments, determining a decision tree for each decision node, determining a probability for reaching a terminal node in each fragment, and merging the probabilities obtained from the fragments to find a probability of a future task.

### BACKGROUND OF THE INVENTION

1. Technical Field

The present disclosure generally relates to predictive analytics and more particularly to generating predictions for a future of a case.

2. Discussion of Related Art

In order to predict the behavior of a system, a state space representation may be provided. The states of the system and the transitions between these states model the behavior of the system. Once such a model is built, a future state can be determined from a current state by using transition probabilities and a set of linear equations. If the system has a Markov property, that is, if the future depends only on the current state, closed form expressions can be given for the state probabilities. Methods based on Markov Chains use one-step transition probabilities between states to determine the execution probability of a particular task.

Typically, however, business process models are non-Markovian, so that Markov Chains are applicable to only small subset of real-life problems. Further, state space representation of a business process may be computationally intensive and difficult to manage in the case of representing a state with many variables.

Other solutions include classification techniques such as decision trees under the assumption that the process model does not include parallel execution paths. Such assumptions do not always hold for realistic business process scenarios.

According to an embodiment of the present disclosure, a need exists for a method that does not subscribe to the Markovian assumption that a current state is independent of the past and that will not exclude the process model that contains parallel paths.

### BRIEF SUMMARY

According to an embodiment of the present disclosure, a method for generating predictions includes receiving a business process model and dividing the business process model into a plurality of fragments, wherein the business process model comprises a plurality of nodes including a plurality of task nodes and at least one decision node, wherein each decision node is associated with a plurality of outcomes among the task nodes. The method further includes determining the decision node in at least one of the fragments, determining a decision tree for each decision node, determining a probability for reaching a terminal node in each fragment according to a recorded execution trace of the business process model, merging the probabilities obtained from the fragments to find a probability of a future task, and outputting a tangible indication of the probability of the future task.

According to an embodiment of the present disclosure, a method for generating predictions includes dividing a business process model into fragments, wherein the business process model includes task nodes and at least one decision node, determining the decision node in at least one of the fragments, determining a decision tree for each decision node, determining a probability for reaching a terminal node in each fragment, and merging the probabilities obtained from the fragments to find a probability of a future task.

### BRIEF DESCRIPTION OF THE SEVERAL VIEWS OF THE DRAWINGS

Preferred embodiments of the present disclosure will be described below in more detail, with reference to the accompanying drawings:

FIG. 1 is a flow diagram for determining a probability of an outcome in a business process by using fragmentation;

FIG. 2 illustrates a fragmentation splitting rule according to an embodiment of the present disclosure;

FIG. 3 is a flow diagram for determining fragments in a business process model;

FIG. 4 is an exemplary business process model according to an embodiment of the present disclosure;

FIG. 5 is a first fragment generated from the business process model of FIG. 4 according to an embodiment of the present disclosure;

FIG. 6 is a second fragment generated from the business process model of FIG. 4 according to an embodiment of the present disclosure;

FIG. 7 is a third fragment generated from the business process model of FIG. 4 according to an embodiment of the present disclosure;

FIG. 8 is a forth fragment generated from the business process model of FIG. 4 according to an embodiment of the present disclosure;

FIG. 9 illustrates the fragments of the business process model of FIG. 4 according to an embodiment of the present disclosure;

FIG. 10 shows decision points in each fragment of the business process model of FIG. 4 according to an embodiment of the present disclosure;

FIG. 11 is a flow diagram for extracting execution traces for fragments in a business process model according to an embodiment of the present disclosure;

FIG. 12 shows an open form of a decision tree learned from the execution traces displayed in Table 1 according to an embodiment of the present disclosure;

FIG. 13 is a flow diagram for determining probabilities for reaching a target node in a business process model according to an embodiment of the present disclosure;

FIG. 14 shows possible paths after performing a depth first search from task a to task e in the business process model of FIG. 4 according to an embodiment of the present disclosure; and

FIG. 15 shows an exemplary computer system for performing a method for data driven prediction generation according to an embodiment of the present disclosure.

### DETAILED DESCRIPTION

According to an embodiment of the present disclosure, predictions may be generated from a probabilistic process model (PPM) mined from case instances of a business processes. The predictions may indicate a likelihood of different outcomes in a currently executing business process instance, such as the likelihood of executing a particular activity in the future given the state of current activity.

The business process may be structured (where the steps and their sequence are known), semi-structured, or unstructured (where the steps and their sequence vary from case to case). In the semi-structured business process (also referred to as a case), the order of activities to be performed may depend on factors such as human judgment, document contents, and business rules. Case workers decide which set of steps to take based on data and case information. Exemplary embodiments are described herein in terms predicting which activities will be performed in the future and how the case ends given state of a case. The state includes the activities executed and the data consumed or produced in the past.

A business process instance includes a sequence of activities or tasks, where each activity may have data associated with it. For example, in an automobile insurance process a task may have incoming document related data such as a claim document. Each process instance may also have data associated with it.

It should be understood that any known or future business provenance method may be used to capture, correlate and store events related to an executing business process instance in a trace. Further, any known or future mining method may be used to mine a process model of a business process from a set of execution traces.

According to an embodiment of the present disclosure, the likelihood of different outcomes, such as the likelihood of a future state may be predicted in a currently running business process instance on the basis of available document contents. Decision trees are learned at each decision point in the business process model, which is mined from a set of execution traces of the business process. Every task or activity with transitions to multiple tasks is a potential decision node in a PPM. The decision trees may be used to make predictions about the likelihood that different tasks will execute in the business process.

The business process may exhibit complex behavior, such as parallel task execution. This structural behavior has implications for predicting the likelihood of which tasks will be executed next. For example, parallelism upstream from a task in a process model may signify multiple paths to reach that task that influences the probability that it will execute. Moreover, a decision tree approach cannot be applied immediately if a parallel execution path exists. A prediction method according to an embodiment of the present disclosure may leverage the decision trees while taking the structural information of the business process into account. Such a prediction method may leverage decision tree predictions and combine them with other techniques of probability theory that take potential parallelism contained in the process model of the business process into account.

The following assumptions may be used in the following disclosure:

Described methods support INCLUSIVE, EXCLUSIVE, and PARALLEL gateways in a process model.

The process model can contain parallel executions, splits, and/or joins.

In the disclosure the following definitions apply, unless otherwise noted:

Fragment: graph of vertices and edges that contains only OR/XOR gateways but not an AND gateways (parallel executions) are called fragments.

Path: A sequence of vertices such that from each of its vertices there is an edge to the next vertex in the sequence is called path.

Terminal node: A vertex with no outgoing edges is called a terminal node.

Target node: A vertex that is being predicted as named as target node.

Starting node: A vertex that is used to start making predictions from is called a starting node.

A fragment represents a potential execution path in a business process that does not contain any parallel path. A business process model with parallel execution paths can be decomposed into a set of fragments. This way each fragment can be analyzed independent of each other.

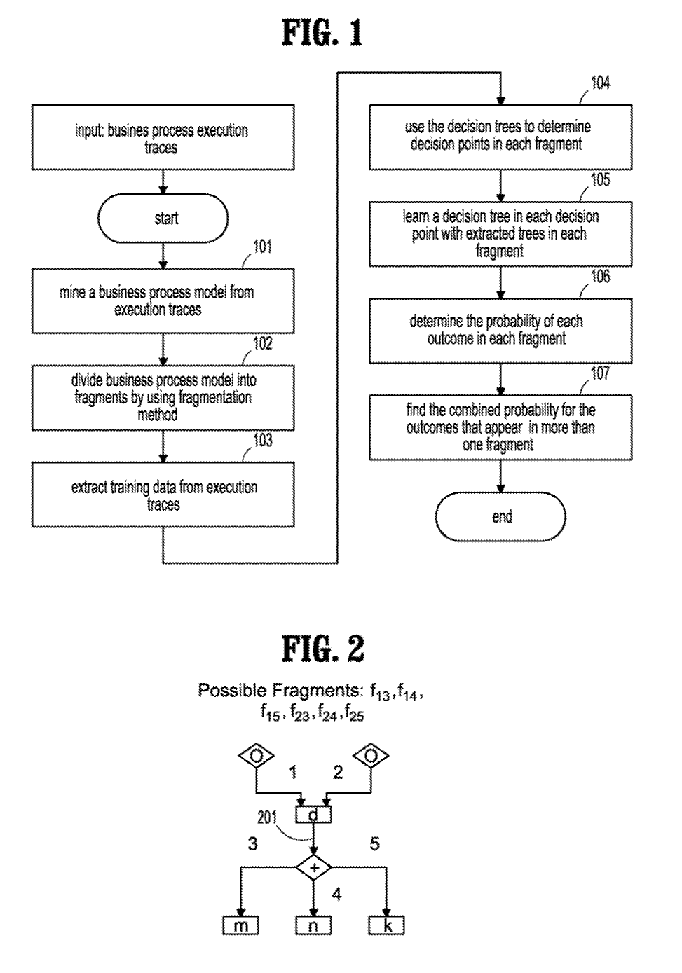

FIG. 1 is a flow diagram that describes a method of finding the probability of an outcome in a business process by using fragmentation.

The process of finding the probability of an outcome in a business process model takes as input a plurality of business process execution traces for past executions. This historical data may be used as an input to create a business process model by mining the process with the business process execution traces (block 101). After obtaining the business process model, a, fragmentation method may be used to decompose the business process model into fragments (block 102), where each fragment will contain only OR/XOR type of gateways. In block 103, execution traces for each fragment may be executed by considering the task nodes of the fragments. If the executed task is not included in the fragment as a task, corresponding execution task will be excluded from the execution trace for that fragment. In block 104, decision points on each fragment may be determined by going through each task/gateways. In block 105, the decision trees for each fragment may be trained by using the extracted execution traces. After training the decision trees in block 105, probabilities of all possible outcomes may be obtained using the trained decision trees for each fragment in block 106. These probabilities may be used in block 107 to determine a combined probability for the tasks that appear in more than one fragment. In view of the foregoing, a probability of executing a task from a given task may be determined using decision trees.

Fragmentation

In this section, the creation of fragments from a business process model that contains parallel execution paths is explained. Referring to incoming and outgoing edges of an AND gateway (for a fragmentation method); if M represents the number of incoming edges and N represents the number of outgoing edges, when M=2 and when N=3, the example below demonstrates the possible paths that need to be considered while executing the fragmentation method.

FIG. 2 illustrates the potential fragments of a business process with parallel execution paths. Referring to FIG. 2, for a fragmentation method, the flow coming from vertex d (201) splits into 3 parallel paths (3, 4, 5). Hence, a number of fragments are formed. The number of possible single execution paths around an AND gate can be calculated as M×N (the number of incoming edges multiplied by the number of outgoing edges). In this example, there are 6 single execution paths around the AND gateway which yield to 6 fragments. These are f₁₃, f₁₄, f₁₅, f₂₃, f₂₄, f₂₅.

### Notation:

V: Task nodes in the process model.

E: Control flow in the process model (edges)

F: Set of fragments

fᵢⱼ: ij^{th} fragment

lᵢ_{_{—}}fᵢⱼ: fragment label of the vertex i

D: Set of decision trees

dᵢⱼ^{k}: Decision tree that is associated to ij^{th} fragment's k^{th} decision point

N: Outgoing edges from a vertex

M: Incoming edges into a vertex

Pᵢⱼ: Probability of executing task i, knowing that task j is already executed

Gⱼ: Probability of reaching to target node from the starting node in fragment j

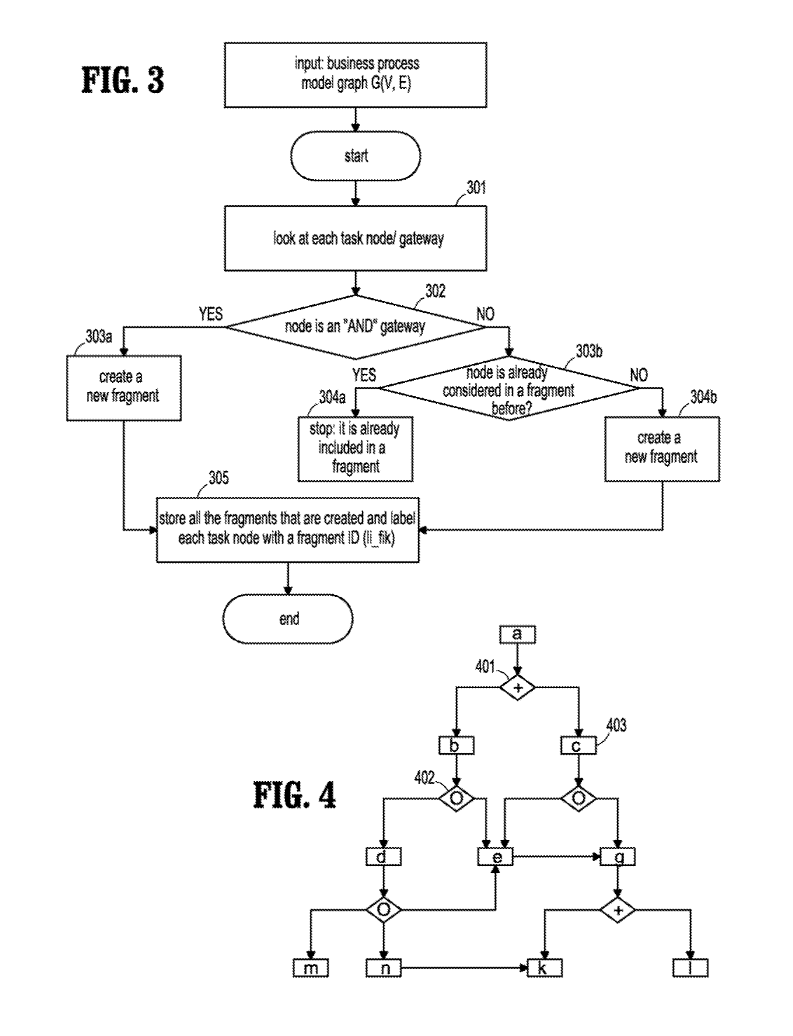

Referring to the determination of fragments (block 102), let G (V, E) represent the business process model, where V is the number of task nodes and E is the number of edges (control flow). Given these definitions, FIG. 3 is a flow diagram for describing a method of fragment determination. Fragmentation method takes the business process model (G(V,E)) as an input and returns fragmented business process models as an output. As FIG. 3 shows, each individual task/gateway is examined (block 301). The method checks whether a node is an AND gateway or not (block 302). If it is an AND gateway, the method creates a new fragment by considering all possible incoming and outgoing edge combinations (block 303a, see FIG. 2). The conditions for including a new task node or a gateway to a fragment is as follows: 1) a node to be added cannot be connected to an AND gateway and 2) a node to be added cannot have same exact same pattern of addition to the fragment. The addition of a node will be recursively repeated for each connected node until this connected node's connections are all considered. Note that if the added task is a terminal node, there is no need to look at its connections since it doesn't have any connected nodes. If the node considered at the decision block (302) is not an AND gateway and if it is not included to any of the fragments before (block 303b), then a new fragment will be created (block 304b). If the node is not an AND gateway but considered in a fragment previously (block 304a), then the method will stop and will not further include that node to any other fragment. After creating all the fragments, each of them will be stored individually and then the task nodes and gateways that are included in each fragment will be labeled by a unique fragment ID (block 305).

FIG. 4 shows an exemplary business process model with 2 AND (e.g., 401), 3 OR gateways (e.g., 402), and 10 nodes (e.g., 403). There are 2 outgoing edges from the first AND and 2 outgoing edge from the second AND gate. Hence, 2 execution paths are generated starting from the input of the first AND gate (a->b, a->c) and 2 from the input of the second (g->k, g->l). Since each execution path produced by the first AND gate reaches the second AND gate through vertex g and the fact that second AND gate has two outgoing edges, one can conclude that there are 2×2=4 potential single execution paths. This yields to 4 fragments.

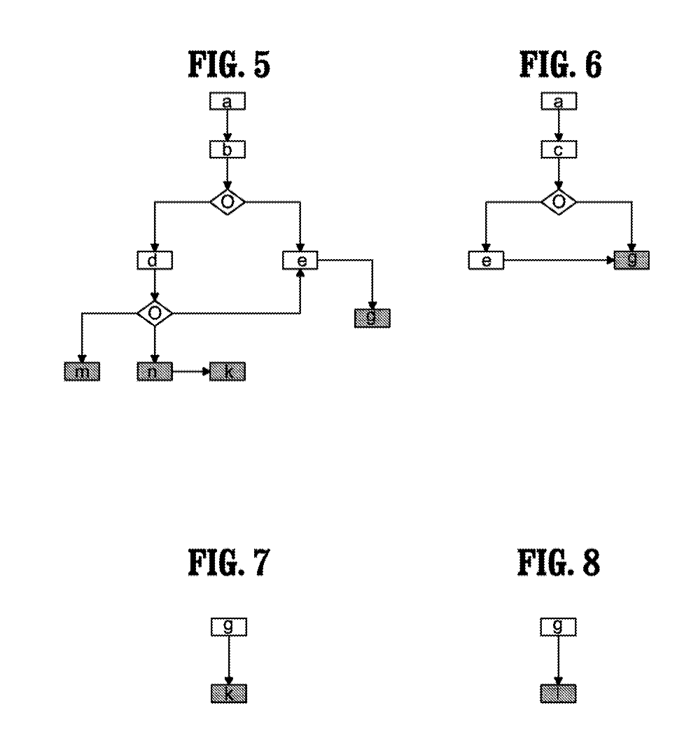

Given the mined business process model of FIG. 4, the first of the four fragments that constitutes the business process may be generated according to the flow diagram of FIG. 3. The method starts by examining each individual task node and gateway. The first AND gateway encountered after task a starts the first fragment. Method creates the fragment from the edge between task a to task b. It will include task a's connections b, d, e, m, n and k. The addition of the connections stops at task nodes m, n and k since they are terminal nodes. FIG. 5 shows the fragment generated by following the fragmentation method described above. In FIG. 5, node g has a vertex connected to an AND gateway.

The second of the four fragments may be generated as follows: The method will keep creating a new fragment from the first AND split. The second fragment will start with the task node a and task node c connection. After adding task c, its connections will be considered. Task nodes e and g will be added after task node c and then method will terminate itself since task node e is a terminal node and task node g is connected to an AND gateway. FIG. 6 shows the fragment generated as a result.

The third of the four fragments may be generated as follows: The method will go through each node and determine that each node until the AND gateway between task node g and task nodes k and l is not considered. The third fragment is created by taking the task g and connecting it to task node k. The creation of this fragment will end at task node k since k is a terminal node. FIG. 7 shows the third fragment generated.

A fourth fragment may be generated as follows: The method will keep creating a new fragment from the second AND split. The fourth fragment starts with the task node g and task node l connection. The creation of this fragment ends at task node l since l is a terminal node. FIG. 8 shows the fourth fragment generated.

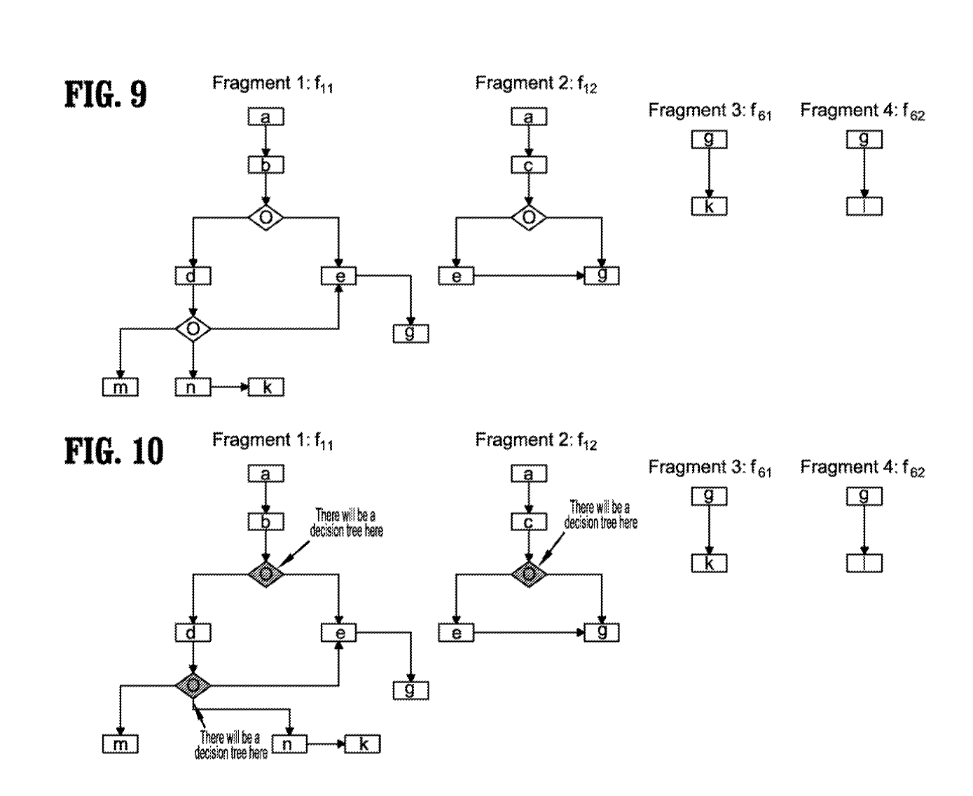

All of the fragments that are generated by the fragmentation method are shown in FIG. 9.

Extracting Training Data for Decision Trees

Referring to a business process model as shown in FIG. 4 with 2 AND, 3 OR gateways, and 10 nodes, after applying the fragmentation method, training data may be extracted from execution traces.

After decomposing the business process model into |F| fragments, training data may be extracted from the execution traces for each fragment {f11, f12, . . . , f|F|}. The training data collected for each fragment is used to learn a decision tree at each decision point in each fragment. A decision point in a fragment is a gateway where the execution can split into alternate paths depending on certain conditions such as the values of data attributes. A decision point is present at each XOR or OR gateway in the process model because at these gateways execution can split into different paths. FIG. 10 shows the decision points in each fragment of the process model in FIG. 4. One decision point represents the determination of which task will be executed after task b. Another decision point represents the determination of possible next states after d and yet another decision point is positioned after task node c.

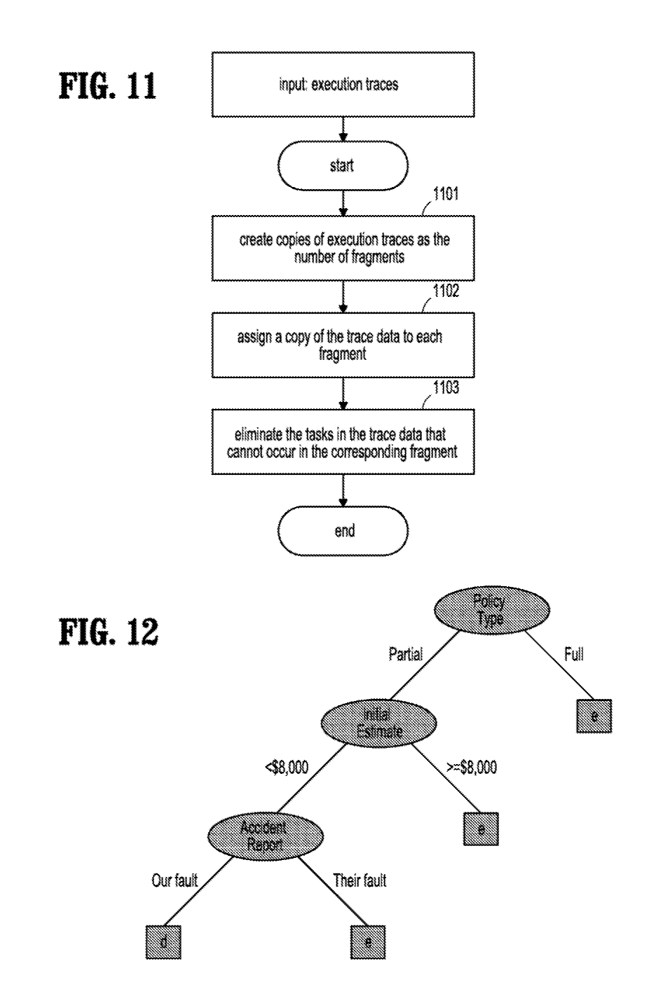

To be able to extract the training data, the method of FIG. 11 may be used. For example, given an execution trace, T: a b d c e n g k l, for a business process model, the training data sequence for fragment 1 is obtained from a copy of the trace data by eliminating tasks c, g and l which do not belong to fragment 1. The other examples follow the same principle.

Training sequence for fragment 1: a b d [symbol] e n [symbol] k [symbol] yields: a b d e n k

Training sequence for fragment 2: a [symbol] c e [symbol] g [symbol] yields: a c e g

Training sequence for fragment 3: [symbol] g [symbol] l yields: g k

Training sequence for fragment 4: a b d c en g k L yields: g l

Referring now to the training of the decision trees; after extracting the training sequences and identifying the decision points within each fragment, the method determines whether the particular decision point is influenced by the case data or not. For example, a case instance with particular properties might follow a particular pattern. In order to detect such structural patterns based on the case data, machine-learning techniques can be used. Machine learning algorithms can learn the behavior of the data and then predict the behavior of a specific instance based on what it learnt from the similar patterns that have occurred in the past.

The method may convert every decision point into a classification problem [1, 2, 3, 4], where the classes are the different decisions that can be made. In order to solve such classification problems, the decision tree method can be used. A decision tree can be trained by using many execution traces and likelihood of a particular outcome can be determined by choosing one of the classification techniques, such as C5, CHAID, etc.

As an example, consider the business process model that is represented in FIG. 4.

The fragmented business process model (see FIG. 9) may be interpreted as an insurance industry process. In a scenario for an insurance industry, task node b may be a decision point for a car to be investigated by third party (task node e) or not (task node d). As training samples, the process instances that have occurred in the past may be used. The attributes that will be analyzed are the case attributes that are obtained until the decision point, which may be used to predict the behavior of the desired case. Now consider the decision point after executing task b (with following data attributes: claim ID, accident report, policy type, and estimate initial). Below table summarizes where the old process instances ended up with the given four data attributes.

TABLE 1
Training examples for d₁₁¹

| | Accident | | Initial | | |
|---|---|---|---|---|---|
| Claim ID | Report | Policy Type | Estimate | Decision | Task |
| 1183982 | Their fault | Full | $2,300 | Third party | e |
| 1298437 | Their fault | Full | $4,500 | Third party | e |
| 8683929 | Our fault | Partial | $2,200 | No third | d |
| | | | | party | |
| 3268739 | Their fault | Partial | $10,800 | Third party | e |
| 3218116 | Our fault | Full | $5,400 | Third party | e |
| 4567389 | Our fault | Partial | $7,600 | No third | d |
| | | | | party | |
| 6372847 | Their fault | Partial | $4,300 | Third party | e |

The decision tree of FIG. 12 (which is denoted by d₁₁¹) is learned by using the data given in Table 1. FIG. 12 is an open form of decision tree d₁₁¹ as indicated in FIG. 10 after node b.

Using a C 5.0 decision tree algorithm (in the IBM software SPSS), which is an inductive inference algorithm and provides information for the prediction results. C 5.0 algorithm can be used when there are continuous variables (such as initial estimate attribute), nominal variables (such as policy type attribute) or missing values. A decision tree algorithm sorts the instances down the tree, from root to some leaf node, by looking at the statistical properties of the training data. More specifically, C 5.0 builds the decision tree from a set of training data using the concept of information entropy where the uncertainty of the random variables are taken into account while building the tree. The training sequences that are extracted in block 103 of the FIG. 1 are used to train decision trees in each decision point in each fragment. In order to train decision trees within a fragment, the training sequence that is associated with that fragment is used.

As a result, one-step transition probabilities between the activities (such as starting vertex and all other vertices) can be found by exploring the results of the decision tree that is generated at every decision point.

Likelihood of Executing a Task

Referring to the determination of a probability that a task will execute; the reason for creating decision trees and training them with information from historical process execution traces is to give a case worker information about the likelihood of possible choices. More specifically, given that the case worker executed task a, the decision tree helps to find the likelihood of executing other tasks after the current task based on available data attributes at task a. This information can then be used to make predictions about which tasks will be executed in the future. A tangible indication of the probability of reaching the target may be output as a report, displayed value, risk assessment, etc.

The probability of executing a task in the future after executing a particular task can be found by using conditional probabilities. For example, if we are at task a and if we would like to predict the probability of executing task d in the future, we need to find the conditional probability, P(d\a). After training the decision trees on the predefined decision nodes (see in FIG. 10), conditional probabilities can be provided for each fragment by the decision tree.

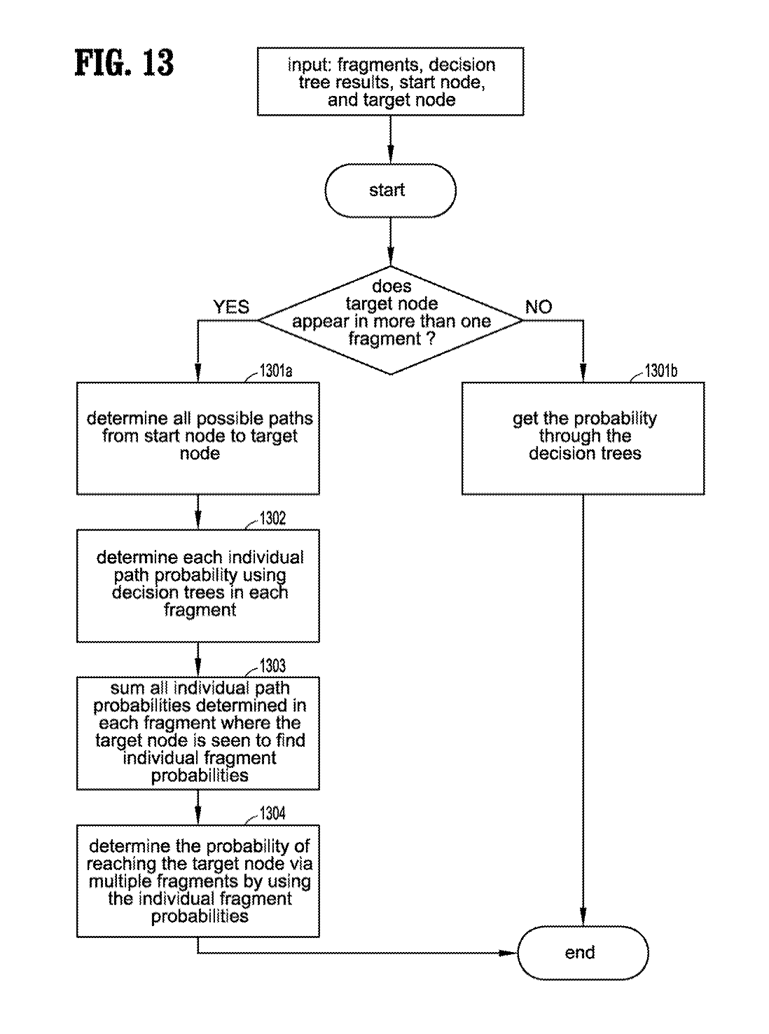

Conditional probabilities for the tasks that only appear once in each fragment can be directly obtained from the decision tree as show in FIG. 13. Using the example below, given that a case worker is executing task node d, there are two possibilities. Either task nodes m or n will execute next. The probability of executing task nodes m or n can be computed by training a decision tree at the decision node after d. However, for the tasks that appear in more than one fragment (such as task nodes e, g, and k), all possible ways of arriving at the target have to be taken into account in order to compute the probability that they will execute.

For tasks that can be reached by more than one path in one fragment, the conditional probability that they will execute may be determined according to the flow diagram of FIG. 13.

Determining the probability of reaching the target node via multiple fragments is done when the target node can be reached by more than once from different fragments. The probability of reaching the target node can be determined as one minus, multiplication of each individual fragment probabilities of not being able to reach to the target node that can be derived from step 1303 of the FIG. 13. (Not being able to reach to the target node within each fragment is one minus probability of reaching that is calculated in step 1303)

For example: to determine the probability of reaching e from a in the business process model that is represented in FIG. 4:

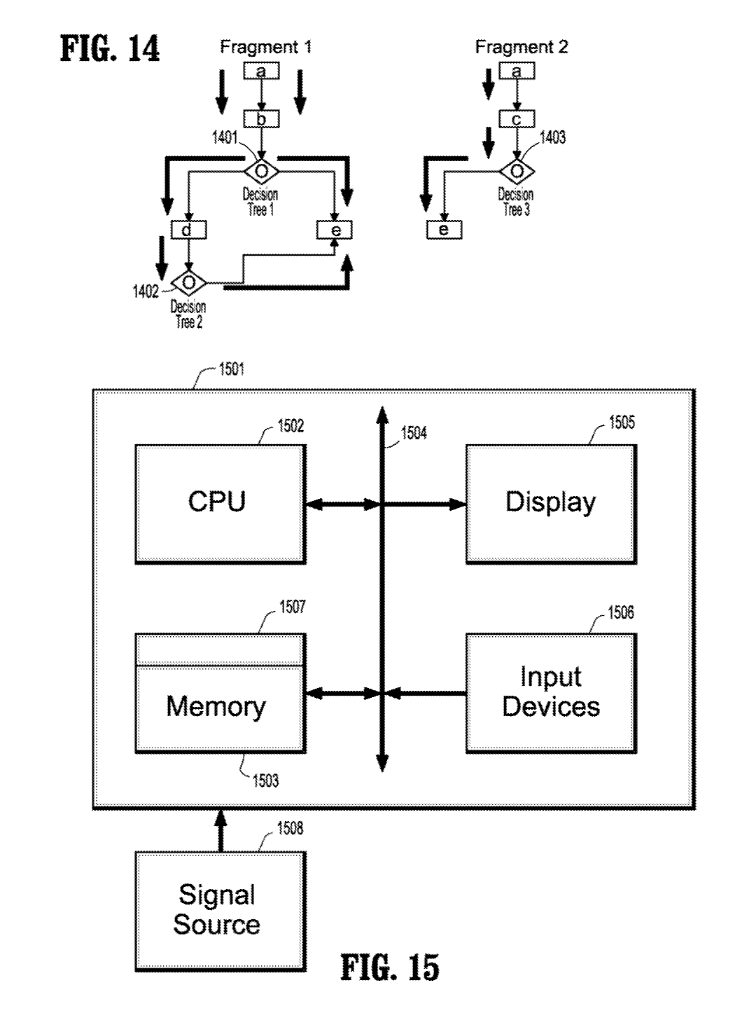

Step 0: Target node is e and it appears in Fragment 1 and Fragment 2.
Step 1: FIG. 14 shows possible paths to reach task node e and the decision trees in each decision point (1401-1403) in each fragment:
Step 2: Conditional probability determination from the decision trees:

1. P(E\A) is calculated via DT1 in fragment 1

2. P(D\A) is calculated via DT1 in fragment 1

3. P(E\D) is calculated via DT2 in fragment 1

4. P(E\A) is calculated via DT3 in fragment 2

Step 3: Joint probability determination:

Pr{Reaching to E via red path}: P₁=P(D\A)×P(E\D

Pr{Reaching to E via green path}: P₂=P(E\A)

Pr{Reaching to E via yellow path}: P₃=P(E\A)

Pr{Reaching to E within fragment 1}: G₁=P₂+P₁

Pr{Reaching to E within fragment 2}: G₂=P₃

Step 4: Final determination:

Pr{Reaching E given A}=1−(1−G₁)(1−G₂)

In general probability of reaching to any activity may be expressed as:

$$1 - {\prod }_{j = 1}^{m} ( 1 - {G}_{j} )$$

where Gⱼ is the probability of reaching the target within fragment j and m is the total number of fragments where the target is reachable. Furthermore,

$${G}_{j} = {\sum }_{n = 1}^{K} {P}_{n j}$$

where Pₙⱼ is the probability of reaching the target through the nth path (from starting node to target node) and K is the total number of paths (from starting node) to target.

It is to be understood that embodiments of the present disclosure may be implemented in various forms of hardware, software, firmware, special purpose processors, or a combination thereof. In one embodiment, a method for predictive analytics for document content driven processes may be implemented in software as an application program tangibly embodied on a computer readable storage medium or computer program product. As such the application program is embodied on a non-transitory tangible media. The application program may be uploaded to, and executed by, a processor comprising any suitable architecture.

Referring to FIG. 15, according to an embodiment of the present disclosure, a computer system 1501 for generating predictions for a future of a case can comprise, inter alia, a central processing unit (CPU) 1502, a memory 1503 and an input/output (I/O) interface 1504. The computer system 1501 is generally coupled through the I/O interface 1504 to a display 1505 and various input devices 1506 such as a mouse and keyboard. The support circuits can include circuits such as cache, power supplies, clock circuits, and a communications bus. The memory 1503 can include random access memory (RAM), read only memory (ROM), disk drive, tape drive, etc., or a combination thereof. The present invention can be implemented as a routine 1507 that is stored in memory 1503 and executed by the CPU 1502 to process the signal from the signal source 1508. As such, the computer system 1501 is a general-purpose computer system that becomes a specific purpose computer system when executing the routine 1507 of the present invention.

The computer platform 1501 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described embodiments for generating predictions for a future of a case, it is noted that modifications and variations can be made by persons skilled in the art in light of the above teachings. It is therefore to be understood that changes may be made in exemplary embodiments of disclosure, which are within the scope and spirit of the invention as defined by the appended claims. Having thus described the invention with the details and particularity required by the patent laws, what is claimed and desired protected by Letters Patent is set forth in the appended claims.

What is claimed is:

1. A method for generating predictions comprising:
receiving a business process model;
dividing the business process model into a plurality of fragments, wherein the business process model comprises a plurality of nodes including a plurality of task nodes and at least one decision node, wherein each decision node is associated with a plurality of outcomes among the task nodes;
determining the decision node in at least one of the fragments;
determining a decision tree for each decision node;
determining a probability for reaching a terminal node in each fragment according to a recorded execution trace of the business process model;
merging the probabilities obtained from the fragments to find a probability of a future task; and
outputting a tangible indication of the probability of the future task.

2. The method of claim 1, wherein the probability of the future task is dependent on the probabilities obtained from the fragments.

3. The method of claim 1, further comprising extracting training data from the execution trace of the business process model.

4. The method of claim 3, wherein the training data includes a unique sequence of task nodes associated with each fragment.

5. The method of claim 3, further comprising:
creating a copy of the execution trace for each fragment, wherein the execution trace lists the task nodes; and
eliminating at least one task node from each copy such that each copy includes only the tasks appearing in a respective fragment.

6. The method of claim 3, wherein determining the decision tree for each decision node further comprises training the decision tree using the execution trace to determine a likelihood of reaching each of the outcomes of the decision node.

7. The method of claim 1, further comprising determining a combined probability for at least one terminal node existing in at least two of the fragments.

8. The method of claim 1, wherein dividing a business process model into a plurality of fragments further comprises:
creating a new fragment for each AND gateway in the business process model and for each node in the business process model not already included in a previously created fragment;
labeling each task node of the business process model with a fragment identification.

9. The method of claim 1, further comprising determining a conditional probability for a task node that can be reached by more than one path in a single fragment among the plurality of fragments.

10. A computer program product for generating predictions, the computer program product comprising:
a computer readable storage medium having computer readable program code embodied therewith, the computer readable program code comprising:
computer readable program code configured to divide a business process model into a plurality of fragments, wherein the business process model comprises a plurality of nodes including a plurality of task nodes and at least one decision node, wherein each decision node is associated with a plurality of outcomes among the task nodes;
computer readable program code configured to determine the decision node in at least one of the fragments;
computer readable program code configured to determine a decision tree for each decision node;
computer readable program code configured to determine a probability for reaching a terminal node in each fragment; and
computer readable program code configured to merge the probabilities obtained from the fragments to find a probability of a future task.

11. The computer program product of claim 10, wherein the probability of the future task is dependent on the probabilities obtained from the fragments.

12. The computer program product of claim 10, further comprising computer readable program code configured to extract training data from an execution trace of the business process model.

13. The computer program product of claim 12, wherein the training data includes a unique sequence of task nodes associated with each fragment.

14. The computer program product of claim 12, further comprising:
creating a copy of the execution trace for each fragment, wherein the execution trace lists the task nodes; and
eliminating at least one task node from each copy such that each copy includes only the tasks appearing in a respective fragment.

15. The computer program product of claim 12, wherein determining the decision tree for each decision node further comprises training the decision tree using the execution trace to determine a likelihood of reaching each of the outcomes of the decision node.

16. The computer program product of claim 10, further comprising computer readable program code configured to determine a combined probability for at least one terminal node existing in at least two of the fragments.

17. The computer program product of claim 10, wherein dividing a business process model into a plurality of fragments further comprises:
creating a new fragment for each AND gateway in the business process model and for each node in the business process model not already included in a previously created fragment;
labeling each task node of the business process model with a fragment identification.

18. The computer program product of claim 10, further comprising computer readable program code configured to determine a conditional probability for a task node that can be reached by more than one path in a single fragment among the plurality of fragments.
